(19) United States
(12) Patent Application Publication
(10) Pub. No.: US 2025/0285608 A1
(43) Pub. Date: Sep. 11, 2025

(54) Electronic Drum

(71) Applicant: Ef-Note Inc., Hamamatsu-shi (JP)

(72) Inventors: Tatsuya KOMORI, Hamamatsu-shi (JP); Yoshiaki MORI, Hamamatsu-shi (JP)

(21) Appl. No.: 19/215,870

(22) Filed: May 22, 2025

Related U.S. Application Data
(63) Continuation of application No. PCT/JP2023/042208, filed on Nov. 24, 2023.

(30) Foreign Application Priority Data
Nov. 28, 2022 (JP) 2022-189679

(51) Int. Cl. G10H 3/14; G10D 13/10

(52) U.S. Cl. CPC G10H 3/146; G10D 13/26

(57) ABSTRACT

An electronic drum has a body 1 with a head 2 and a first rim 3; a second rim 4; a head sensor 10; a first rim sensor 11; a second rim sensor 12; and a sound source part 13 configured to produce and output a predetermined musical sound based on a detection signal. The sound source part 13 is configured to, when an output of the second rim sensor 12 exceeds a predetermined threshold value, produce a predetermined musical sound based on the output of the second rim sensor 12. The predetermined musical sound based on the output of the second rim sensor 12 is determined based on a detection signal output from the second rim sensor 12, and a detection signal output from the head sensor 10 or the first rim sensor 11.

### CROSS-REFERENCE TO RELATED APPLICATIONS

This application is a continuation of International Application PCT/JP2023/042208, filed Nov. 24, 2023, which claims priority to Japanese Application No. 2022-189679, filed Nov. 28, 2022. The disclosures of the above applications are incorporating herein by reference.

### FIELD

The present disclosure relates to an electronic drum that produces and outputs a predetermined music sound based on a detection signal generated by a hit.

### BACKGROUND

This section provides background information related to the present disclosure which is not necessarily prior art.

An electronic drum as an electronic percussion instrument normally includes: a body having a head and a first rim which are allowed to be hit by a player; a head sensor mounted on the body, and configured to detect a hit on the head; a first rim sensor mounted on the body, and configured to detect a hit on the first rim; and a sound source part configured to produce and output a predetermined musical sound based on a detection signal detected by the head sensor and the first rim sensor. When a player hits a desired hit position with a stick, the head sensor or the first rim sensor can detect and output the hit to the outside of the sound source part, and similar performances to acoustic drum performances can thereby be achieved.

However, for example, Japanese Unexamined Patent Application Publication No. 2018-189809 proposes an electronic drum including a second rim in addition to the head and the first rim as the hit positions. The second rim being provided separately on the outer peripheral edge of the body. In this electronic drum, a hit on the first rim and a hit on the second rim can be distinguished using the difference in vibration frequency per unit time between the vibration frequency caused by the hit on the first rim and the vibration frequency caused by the hit on the second rim.

### SUMMARY

This section provides a general summary of the disclosure, and is not a comprehensive disclosure of its full scope or all of its features.

However, the related art described above has the following problem.

For example, when a player uses a side stick playing method (also referred to as a “cross stick playing method”) of hitting the second rim while placing a hand on the head of the body, the head sensor may generate an output due to vibration caused by the hand in contact with the head before the hitting on the second rim. A problem arises in that even if the second rim is hit with sufficient strength immediately after the output, only a musical sound based on hitting on the head is output. Furthermore, a problem arises in that even if a musical sound based on hitting of the second rim is output, the original vibration caused by the hitting cannot be detected within a predetermined time period due to vibration caused by the hand in contact with the head first. Thus, a musical sound with inaccurate strength is output.

The present disclosure has been made in consideration of the above-described situation. It is an object of the present disclosure to provide an electronic drum that, even immediately after a hit on the head or the first rim, can reliably detect a hit on the second rim, and reliably produce and output a musical sound according to the hit on the second rim.

According to the disclosure, an electronic drum comprises a body having a head and a first rim which are allowed to be hit by a player; a second rim elastically supported and mounted on the body, the second rim being allowed to be hit by a player; a head sensor mounted on the body, and configured to detect a hit on the head and output a predetermined detection signal; a first rim sensor mounted on the body, and configured to detect a hit on the first rim and output a predetermined detection signal; a second rim sensor mounted on the second rim, and configured to detect a hit on the second rim and output a predetermined detection signal; and a sound source part configured to produce and output a predetermined musical sound based on the detection signal output from the head sensor, the first rim sensor or the second rim sensor. The sound source part is configured to, when the output of the second rim sensor exceeds a predetermined threshold value, produce a predetermined musical sound based on the output of the second rim sensor. The predetermined musical sound based on the output of the second rim sensor is determined based on the detection signal output from the second rim sensor, and the detection signal output from the head sensor or the first rim sensor.

According to the disclosure, the electronic drum, when the output of the second rim sensor exceeds a predetermined threshold value, the sound source part is configured to a predetermined musical sound based on the detection signal output from the second rim sensor in relation to a total of a maximum value of the detection signal output from the second rim sensor in a predetermined time period, and a maximum value of the detection signal output from the head sensor or the first rim sensor in a predetermined time period.

According to the disclosure, the electronic drum further includes an AD converter configured to convert analog signals detected by the head sensor, the first rim sensor and the second rim sensor into digital signals, and output the digital signals. The sound source part obtains the total of the maximum values of the output, in a predetermined time period, which has been converted by the AD converter, and determines a hit strength.

According to the disclosure, the electronic drum second rim is mounted on the body with an elastic body interposed between the second rim and the body.

According to the disclosure, the electronic drum second rim is slidable along a peripheral edge of the first rim.

According to the disclosure, the electronic drum when the detection signal from the head sensor exceeds a first minimum threshold value, the detection signal from the head sensor is compared with the detection signal from the first rim sensor or the second rim sensor, and a predetermined musical sound is produced according to a result of the comparison based on the detection signal from the head sensor, the first rim sensor or the second rim sensor, whereas when the detection signal from the second rim sensor exceeds a second minimum threshold value, a predetermined musical sound is produced based on the detection signal from the second rim sensor.

According to the disclosure when the output of the second rim sensor exceeds a predetermined threshold value, the sound source part is configured to produce a predetermined musical sound based on the output of the second rim sensor. The predetermined musical sound based on the output of the second rim sensor is determined based on the detection signal output from the second rim sensor, and the detection signal output from the head sensor or the first rim sensor. Thus, even immediately after a hit on the head or the first rim, it is possible to reliably detect a hit on the second rim, and reliably produce and output a musical sound according to the hit on the second rim.

According to the disclosure, when the output of the second rim sensor exceeds a predetermined threshold value, the sound source part is configured to output a predetermined musical sound based on the detection signal output from the second rim sensor in relation to a total of a maximum value of the detection signal output from the second rim sensor in a predetermined time period, and a maximum value of the detection signal output from the head sensor or the first rim sensor in a predetermined time period. Thus, a musical sound caused by a hit on the second rim can be output according to the strength of the hit on the second rim.

According to the disclosure an AD converter is configured to convert analog signals detected by the head sensor, the first rim sensor and the second rim sensor into digital signals, and output the digital signals. The sound source part obtains the total of the maximum values of the output, in a predetermined time period, which has been converted by the AD converter, and determines a hit strength. Thus, as compared to when the outputs of the head sensor, the first rim sensor and the second rim sensor are added together, then converted to digital signals, the maximum output of the signal convertible by the AD converter can be increased.

According to the disclosure, the second rim is mounted on the body with an elastic body interposed between the second rim and the body. Thus, it is possible to reliably block transmission of vibration between the head, the first rim and the second rim, and reliably produce and output a musical sound according to a hit on the second rim.

According to the disclosure, the second rim is slidable along a peripheral edge of the first rim. Thus, the second rim can be arranged at any position where a player can comfortably play, and a good performance can thereby be achieved.

According to the disclosure, when the detection signal from the head sensor exceeds a first minimum threshold value, the detection signal from the head sensor is compared with the detection signal from the first rim sensor or the second rim sensor, and a predetermined musical sound is produced according to a result of the comparison based on the detection signal from the head sensor, the first rim sensor or the second rim sensor, whereas when the detection signal from the second rim sensor exceeds a second minimum threshold value, a predetermined musical sound is produced based on the detection signal from the second rim sensor. Thus, a hit on the second rim can be preferentially detected by adjusting the first minimum threshold value and the second minimum threshold value as appropriate.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a three-side view illustrating the entire exterior of an electronic drum according to an embodiment of the present disclosure.

FIG. 2 is an exploded perspective view illustrating the electronic drum.

FIG. 3 is a sectional view taken along line III-III in FIG. 1.

FIG. 4(a) is a sectional view taken along line IV-IV in FIG. 1.

FIG. 4(b) is an exploded perspective view illustrating a second rim of the electronic drum.

FIG. 5 is a block diagram illustrating an outline of the configuration of the electronic drum.

FIG. 6a is a flowchart illustrating control in a sound source part of the electronic drum.

FIG. 6b is a flowchart illustrating control in the sound source part of the electronic drum.

FIG. 6c is a flowchart illustrating control in the sound source part of the electronic drum.

FIG. 6d is a flowchart illustrating control in the sound source part of the electronic drum.

FIG. 6e is a flowchart illustrating control in the sound source part of the electronic drum.

FIG. 6f is a flowchart illustrating control in the sound source part of the electronic drum.

FIG. 6g is a flowchart illustrating control in the sound source part of the electronic drum.

FIG. 6h is a flowchart illustrating control in the sound source part of the electronic drum.

Corresponding reference numerals indicate corresponding parts throughout the several views of the drawings.

### DETAILED DESCRIPTION

An embodiment of the present disclosure will be specifically described below with reference to the drawings.

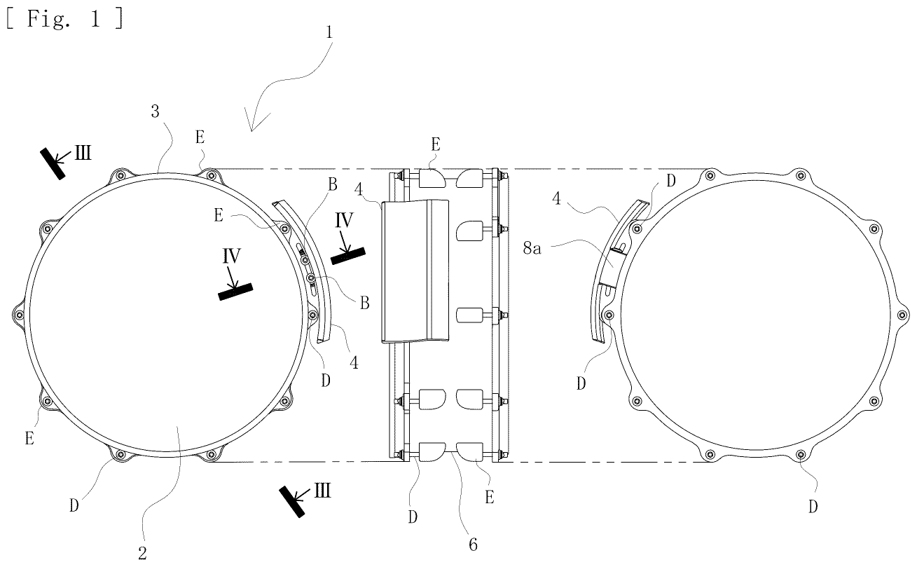

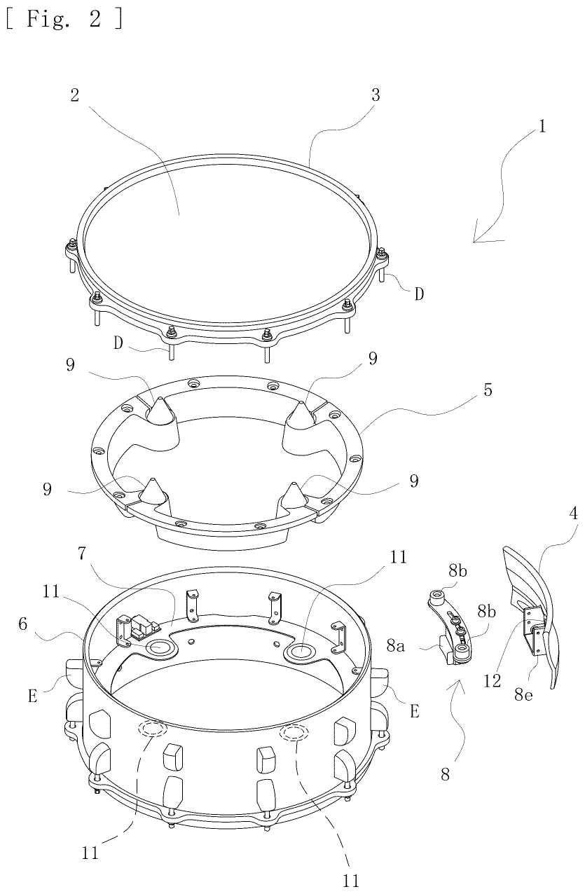

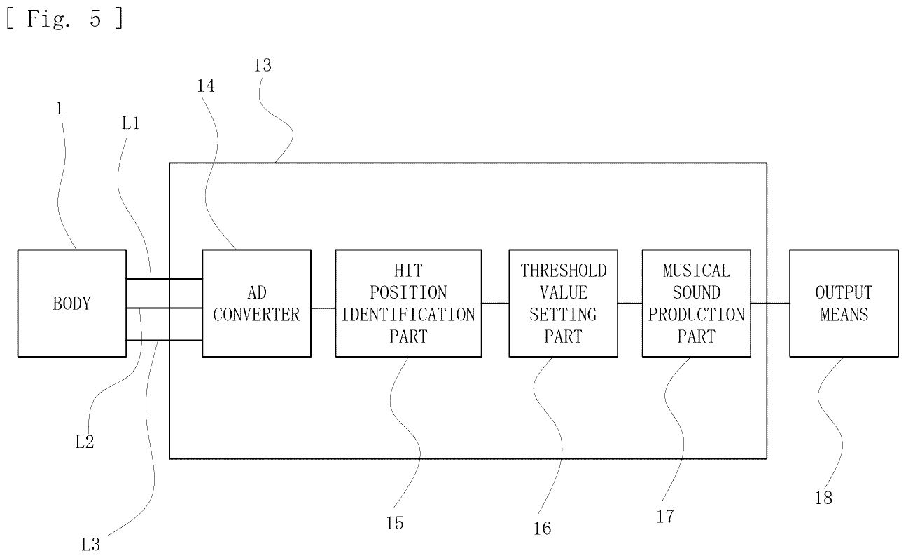

The electronic drum according to the present embodiment produces and outputs a predetermined musical sound based on a detection signal caused by a hit, thereby making it possible to achieve a performance similar to an acoustic drum performance. As illustrated in FIGS. 1 to 5, the electronic drum includes: a body 1; head sensors 10 comprised of a vibration sensor; first rim sensors 11 and a second rim sensor 12 (hit detection parts); and a sound source part 13.

As illustrated in FIGS. 1 to 3, the body 1 includes: a plurality of (three in the present embodiment) hit positions including a head 2, a first rim 3 (rim) and a second rim 4 (side rim) that a player can hit; an annular cover 5 where the head sensors 10 are mounted; a cylindrical housing 6 where the first rim sensors 11 are mounted; and a support member 8 to mount the second rim 4 on the housing 6.

The first rim 3 includes an annular member made of metal covered with an elastic body such as EPDM rubber and PVC. It includes the head 2 made of PET, nylon or the like mounted on the inside of the first rim 3. The first rim 3 is tightened and fixed to rug E formed on the outer peripheral surface of the housing 6 in a projecting manner by tension bolts D. The housing 6 is mounted with an annular plate 7 along the inner circumference, and four first rim sensors 11 are mounted at regular intervals in a circumferential direction of the plate 7.

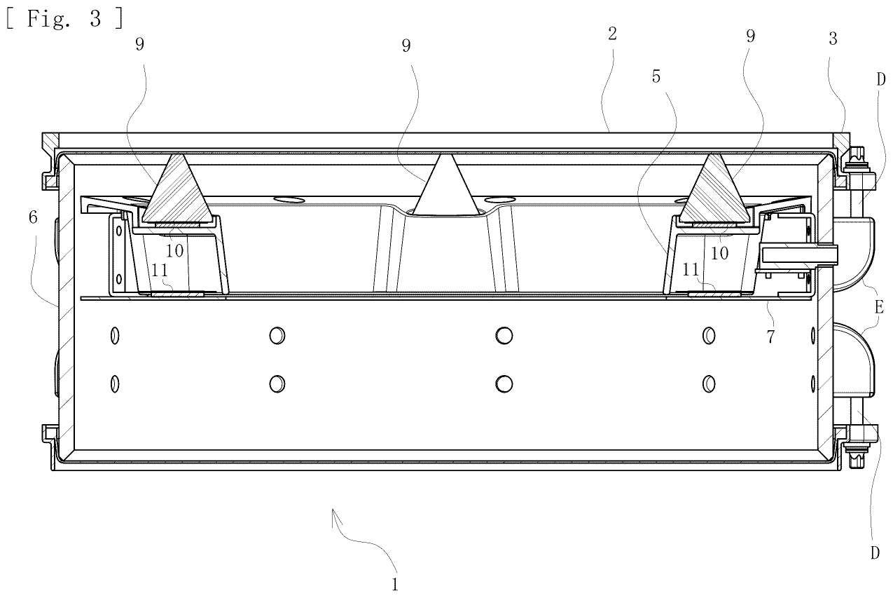

The annular cover 5 is fixed to the inside of the housing part 6. Four conical head sensor cushions 9 are mounted at regular intervals in a circumferential direction of the cover 5. As illustrated in FIG. 3, each head sensor cushion 9 is installed with its tip end in contact with the head 2 and its bottom surface mounted with the head sensors 10. When the head 2 is hit, the head sensors 10 detect vibration through the head sensor cushions 9, and outputs a predetermined detection signal. When the first rim 3 is hit, the first rim sensors 11 detect vibration through the housing 6, and output a predetermined detection signal.

The second rim 4 is elastically supported and mounted on the housing 6 of the body 1. It can be hit by a player, and in the present embodiment, is separately mounted on the housing 6 with elastic bodies 8a, 8b interposed therebetween. The second rim sensor 12 is mounted on the second rim 4. When the second rim 4 is hit, the second rim sensor 12 detects vibration, and outputs a predetermined detection signal.

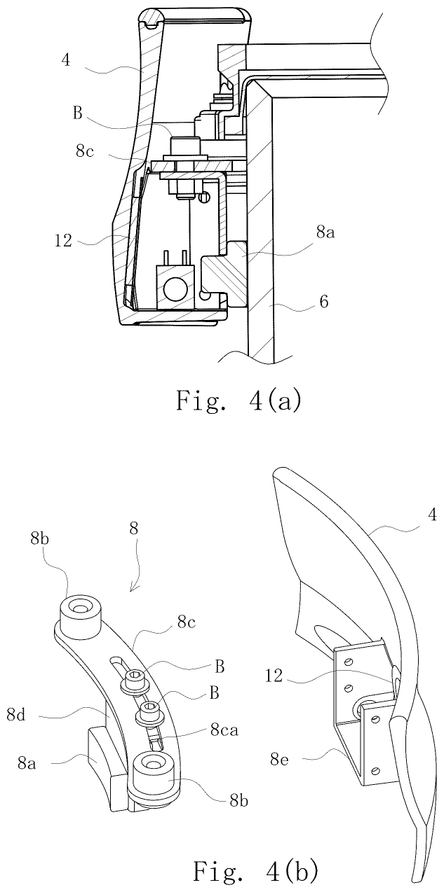

The support member 8 is for elastically supporting the second rim 4 on the lateral side of the housing 6. As illustrated in (a), (b) of FIG. 4, it includes the elastic bodies 8a, 8b made of a rubber material or the like; an arc-shaped support plate 8c; a support stay 8d; and a support member 8e. The support member 8e includes a U-shaped metal stay, and fixed to the second rim 4.

The support plate 8c extends in an arc shape along the profile of the outer peripheral surface of the housing 6, and a long hole 8ca is formed along the arc shape. Two bolts B are inserted into the long hole 8ca, and the support stay 8d is secured by the bolts B. The support stay 8d includes a metal component formed in an L shape, and mounted with a block-shape elastic body 8a. The elastic body 8b is fixed to both ends of the support stay 8d, and is configured to allow a tension bolt D to be internally inserted.

Meanwhile, the support member 8e of the second rim 4 is fixed and integrated with the support stay 8d using screws or the like. A tension bolt D is inserted and screwed into each elastic body 8b, and the second rim 4 is thereby mounted on the lateral side of the housing 6. At this point, the support plate 8c is assembled with the tension bolts D via the elastic bodies 8b. As illustrated in (a) of FIG. 4, the elastic body 8a is in contact with the lateral surface of the housing 6, and the second rim 4 is elastically supported on the housing 6.

The second rim 4 is movable with the support stay 8d along the outer peripheral surface of the housing 6 by loosening the bolts B and moving the second rim 4 along the long hole 8ca. Tightening the bolts B at any position causes the second rim 4 to be fixed to a desired position. In this manner, the second rim 4 according to the present embodiment is slidable along the peripheral edge of the first rim 3. Thus, the second rim 4 can be arranged at any position where a player can comfortably play, and a good performance can thereby be achieved.

The sound source part 13 is configured to produce and output a predetermined musical sound based on the detection signal output from the head sensors 10, the first rim sensors 11 and the second rim sensor 12 serving as the hit detection parts. It includes an AD converter 14, a hit position identification part 15, a threshold value setting part 16, and a musical sound production part 17. The AD converter 14 is electrically connected to the head sensors 10, the first rim sensors 11 and the second rim sensor 12 of the body 1 through wires L1, L2, L3, and configured to convert an analog signal detected by these sensors to a digital signal.

In particular, the sound source part 13, according to the present embodiment, is configured to add maximum values of the output in a predetermined time period, which has been converted by the AD converter 14, and determines a hit strength. Specifically, the sound source part 13, according to the present embodiment, is configured to add the maximum values of the digital signals after converted by the AD converter 14, thus as compared to when the outputs of the head sensors 10, the first rim sensors 11 and the second rim sensor 12 are added together, then converted to digital signals, the maximum output of the signal convertible by the AD converter can be increased.

Meanwhile, the sound source part 13, according to the present embodiment, is configured to, after the detection signal output from the head sensors 10, the first rim sensors 11 and the second rim sensor 12 (the hit detection parts) exceeds a minimum threshold value T(min), produce a musical sound corresponding to the maximum detection signal (the output maximum value V(max)) output in an interval until the predetermined time period t elapses since the exceeding. Note that the minimum threshold value T(min) and the predetermined time period t are pre-set, and stored in a storage (such as a storage medium) included in the sound source part 13. For example, the predetermined time period t according to the present embodiment is set to approximately 2 ms (2/1000 seconds) since the minimum threshold value T is exceeded.

The hit position identification part 15 is comprised of a microcomputer or the like electrically connected to the body 1 via the AD converter 14 through the wires L1 to L3, and identifies the hit positions which have been hit based on the output detection signal from the hit detection parts (the head sensors 10, the first rim sensors 11 and the second rim sensor 12 in the present embodiment). Specifically, the output maximum values V(Hmax), V(R1 max), V(R2 max) from the head sensors 10, the first rim sensors 11 and the second rim sensor 12 are compared, and one of the hit positions, having a highest proportion of output maximum value is identified to be hit.

The threshold value setting part 16 includes the same microcomputer or the like as that of the hit position identification part 15 or another microcomputer or the like connected, and is configured to set a threshold value according to the hit position identified by the hit position identification part 15. The threshold values set by the threshold value setting part 16 according to the present embodiment forms constant threshold values (T(Hα), T(R1α), T(R2α), and gradual decrease lines (T(Hβ), T(R1β), T(R2β)) which gradually decrease with a lapse of time. The gradual decrease line is set individually for each hit position identified by the hit position identification part 15.

For example, when the hit position is identified to be the head 2 by the hit position identification part 15, the threshold value setting part 16 obtains a coefficient α(H) according to the identified head 2, and sets, for a predetermined time t(H), constant threshold value T(Hα) obtained by multiplying the value of a maximum detection signal (an output maximum value V(Hmax)) by the coefficient α(H). The predetermined time t(H) is set individually for each hit position identified by the hit position identification part 15.

Subsequently, a gradual decrease rate γ(H) according to the hit position (the head 2) identified by the hit position identification part 15 is obtained, and a gradual decrease line T(Hβ) is set by consecutively multiplying the gradual decrease rate γ(H) (for each predetermined time) by the value obtained by multiplying the maximum detection signal (the output maximum value V(Hmax)) by the previously obtained coefficient α(H). In this manner, when the hit position is identified to be the head 2, the threshold value set by the threshold value setting part 16 is formed by the constant threshold value T(Hα) and the subsequent gradual decrease line T(Hβ).

For example, when the hit position is identified to be the second rim 4 by the hit position identification part 15, the threshold value setting part 16 obtains a coefficient α(R2) according to the identified second rim 4, and sets, for a predetermined time t(R2), constant threshold value T(R2α) obtained by multiplying the value of the maximum detection signal (the output maximum value V(R2 max)) by the coefficient α(R2). The predetermined time t(R2) is set individually for each hit position identified by the hit position identification part 15.

Subsequently, a gradual decrease rate γ(R2) according to the hit position (the second rim 4) identified by the hit position identification part 15 is obtained, and a gradual decrease line T(R2β) is set by consecutively multiplying the gradual decrease rate γ(R2) (for each predetermined time) by the value obtained by multiplying the maximum detection signal (the output maximum value V(R2 max)) by the previously obtained coefficient α(R2). In this manner, when the hit position is identified to be the second rim 4, the threshold value set by the threshold value setting part 16 is formed by the constant threshold value T(R2α) and the subsequent gradual decrease line T(R2β). Note that when the hit position is identified to be the first rim 3, the threshold value set by the threshold value setting part 16 is formed by the constant threshold value T(R1α) and the subsequent gradual decrease line T(R1β).

The musical sound production part 17 is comprised of the same microcomputer or the like as that of the threshold value setting part 16 and the hit position identification part 15 or another microcomputer or the like connected, and is configured to produce and output a predetermined musical sound based on the detection signal which has exceeded the threshold value set by the threshold value setting part 16. The musical sound production part 17 is connected to the output means 18 which is connected to the sound source part 13, thus the produced musical sound can be output to the output 18. The output 18 is a speaker and a headphone by which a player and an audience actually listen to an output musical sound, and is configured to receive and output the musical sound produced by the musical sound production part 17 through an electrical wire or an optical wire or wirelessly, for example.

The sound source part 13 according to the present embodiment is configured to, when the output of the second rim sensor 12 exceeds a predetermined threshold value, produce a predetermined musical sound based on the output of the second rim sensor 12. The predetermined musical sound based on the output of the second rim sensor 12 is determined based on a detection signal output from the second rim sensor 12 and detection signal output from each head sensor 10 or each first rim sensor 11 (the head sensor 10 and the first rim sensor 11 in the present embodiment).

The sound source part 13 according to the present embodiment is configured to, when the output of the second rim sensor 12 exceeds a predetermined threshold value, output a predetermined musical sound based on the detection signal output from the second rim sensor 12 in relation to the total of a maximum value of the detection signal output from the second rim sensor 12 in a predetermined time period, and a maximum value of the detection signal output from each head sensor 10 or each first rim sensor 11 (the head sensor 10 and the first rim sensor 11 in the present embodiment) in a predetermined time period.

In addition, the sound source part 13 according to the present embodiment is configured to, when the detection signal from the head sensor 10 exceeds a first minimum threshold value (minimum threshold value T(Hmin)), compare the detection signal from the head sensor 10 with the detection signal from the first rim sensor 11 or the second rim sensor 12, and produce a predetermined musical sound according to the result of the comparison based on the detection signal from the head sensor 10, the first rim sensor 11 or the second rim sensor 12. Also, the sound source part 13 is configured to, when the detection signal from the second rim sensor 12 exceeds a second minimum threshold value (minimum threshold value T(R2 min)), produce a predetermined musical sound based on the detection signal from the second rim sensor 12. Note that the first minimum threshold value (minimum threshold value T(Hmin)) and the second minimum threshold value (minimum threshold value T(R2 min)) are pre-set as appropriate.

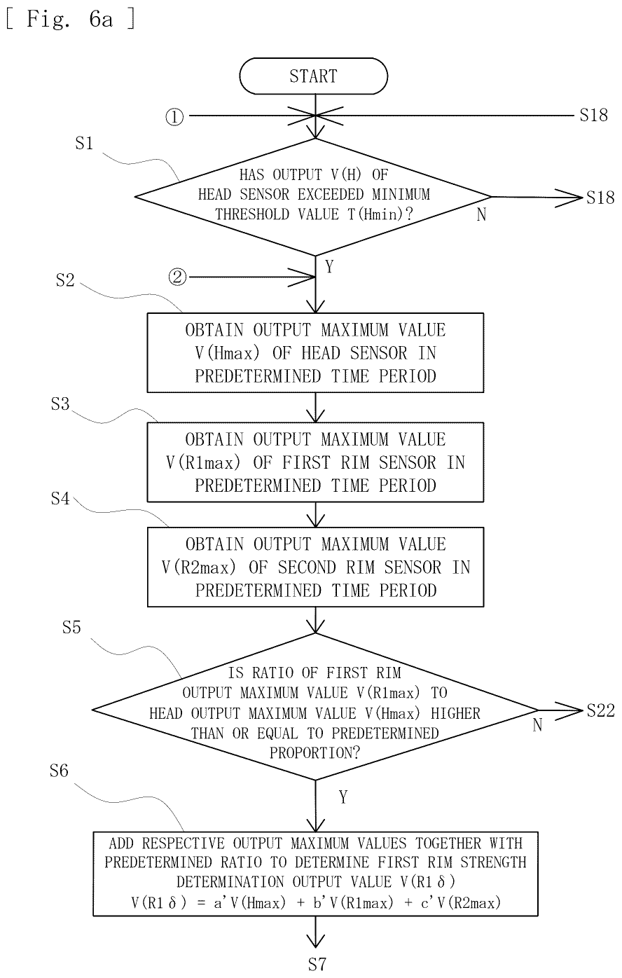

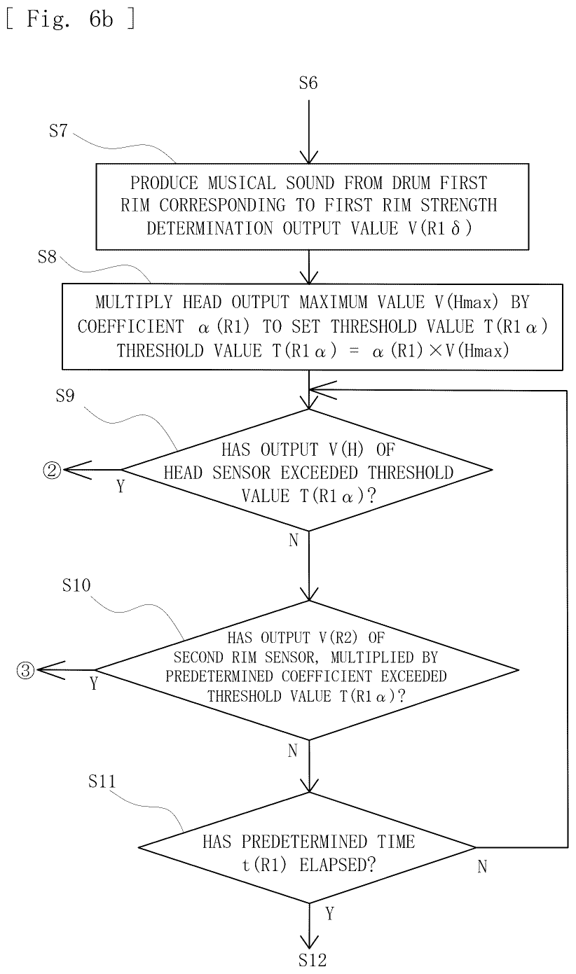

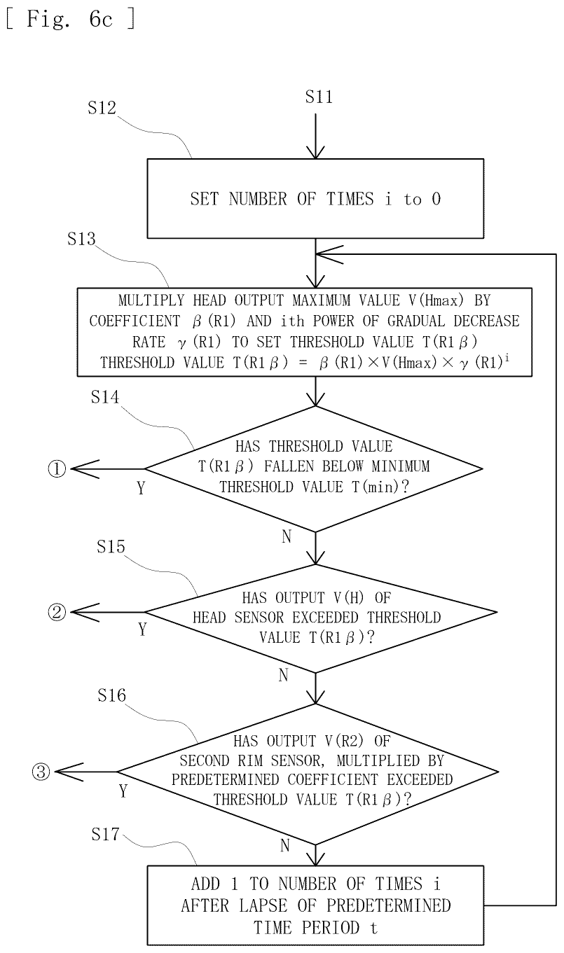

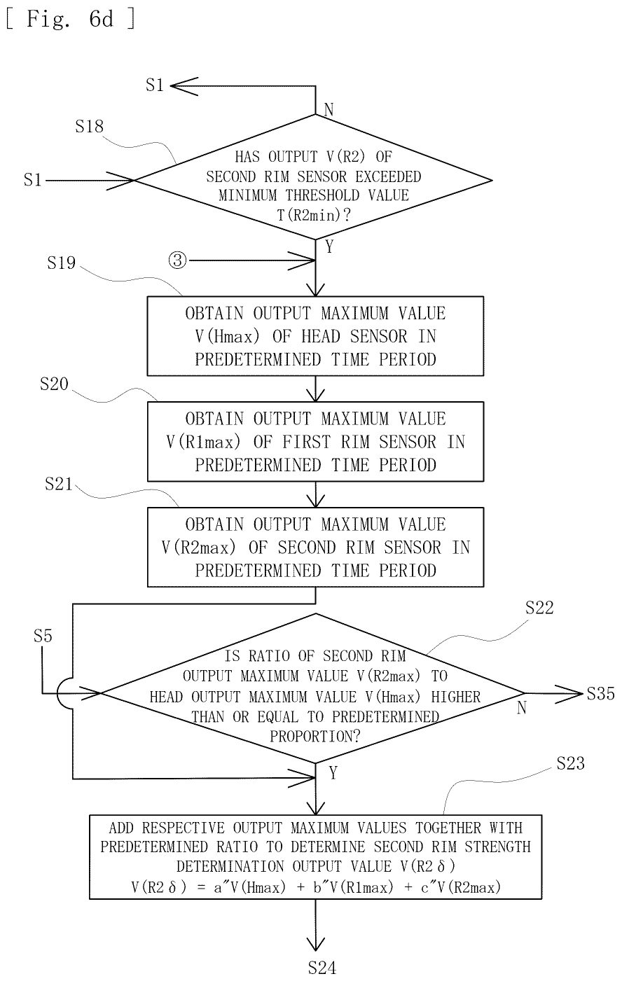

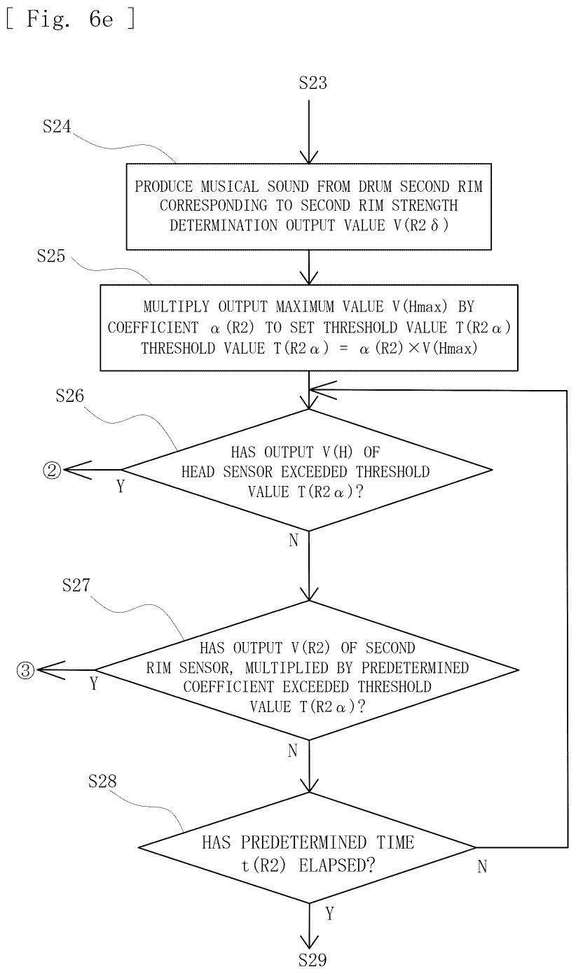

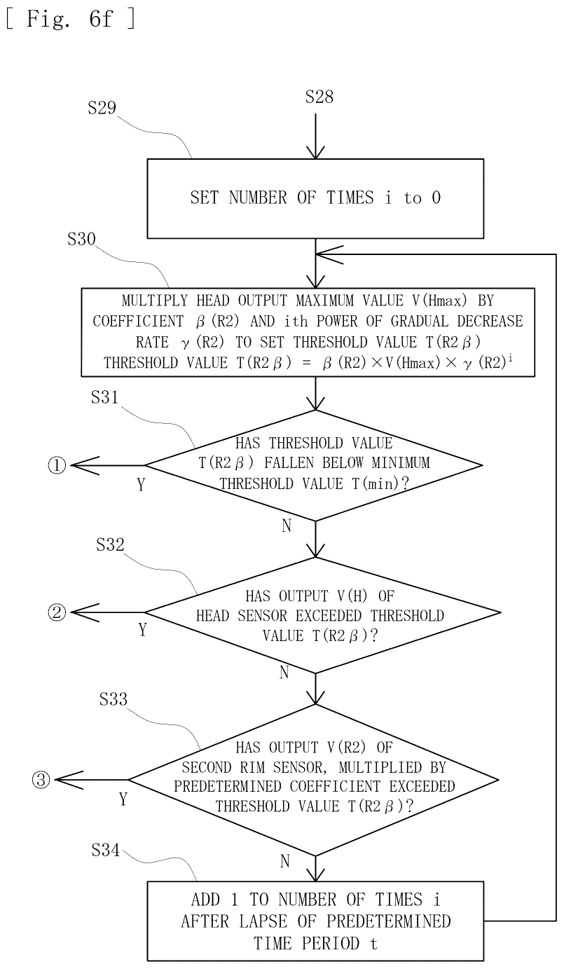

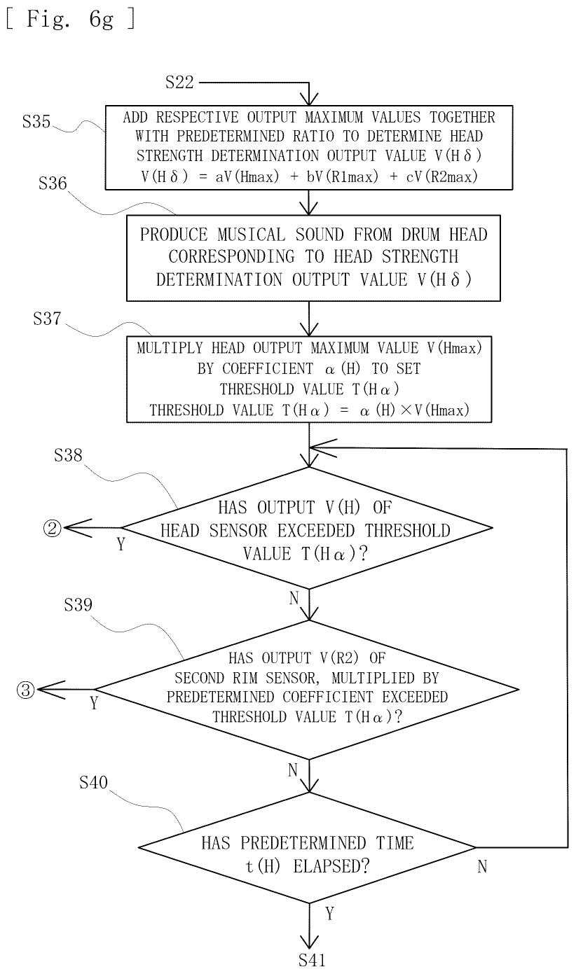

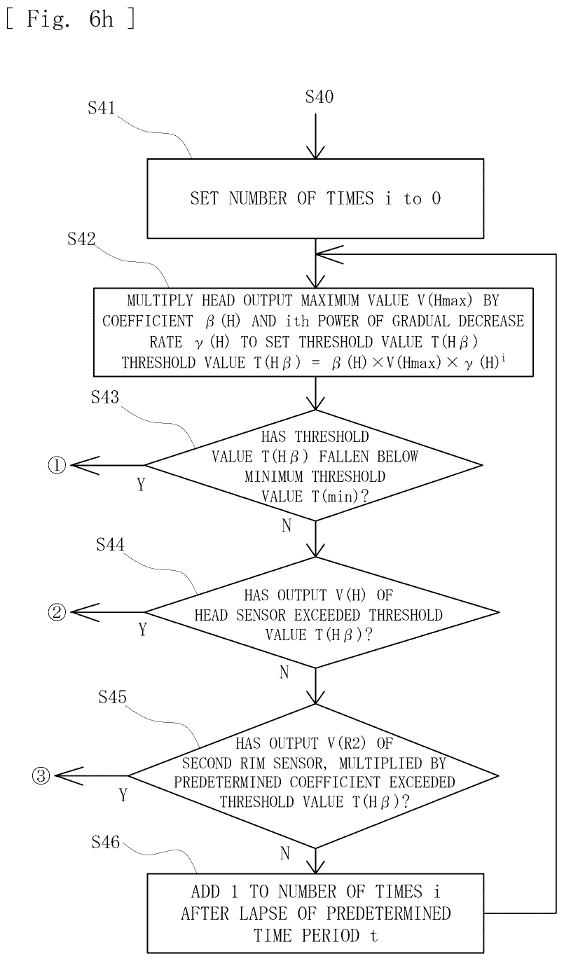

Next, the control of the sound source part 13 according to the present embodiment will be described based on FIGS. 6a to 6h.

First, in S1, it is determined whether the output V(H) (detection signal) of each head sensor 10 has exceeded a minimum threshold value T(Hmin) (a first minimum threshold value), and when the determination is affirmative, in S2, the output maximum value V(Hmax) of the head sensor 10 in a predetermined time period is obtained. Subsequently, in S3, the output maximum value V(R1 max) of the first rim sensor 11 in the predetermined time period is obtained, and in S4, the output maximum value V(R2 max) of the second rim sensor 12 in the predetermined time period is obtained.

Subsequently, in S5, it is determined whether the ratio of the output maximum value V(R1 max) of the first rim sensor 11 in the predetermined time period to the output maximum value V(Hmax) of the head sensor 10 is higher than or equal to a predetermined proportion. When the determination is affirmative, the flow proceeds to S6, and the respective output maximum values V(Hmax), V(R1 max) and V(R2 max) are added together with a predetermined ratio to determine a first rim strength determination output value V(R1δ), otherwise, the flow proceeds to S22, and the subsequent control is performed.

In S7, a musical sound (a musical sound when the first rim 3 is hit) from the drum first rim corresponding to the first rim strength determination output value V(R1δ) is produced by the output 18. Subsequently, in S8, the head output maximum value V(Hmax) is multiplied by the coefficient α(R1) to set the threshold value T(R1α) (constant threshold value), then it is determined in S9 whether the output V(H) of the head sensor 10 has exceeded the threshold value T(R1α) (constant threshold value).

In S9, when the output V(H) of the head sensor 10 is determined to have exceeded the threshold value T(R1α) (constant threshold value), the flow returns to S2 and the subsequent control is repeated. When the output V(H) of the head sensor 10 is determined not to have exceeded the threshold value T(R1α) (constant threshold value), it is determined in S10 whether the output V(R2) of the second rim sensor 12, which has been multiplied by a predetermined coefficient has exceeded the threshold value T(R1α).

In S10, when the output V(R2) of the second rim sensor 12, multiplied by a predetermined coefficient is determined to have exceeded the threshold value T(R1α), the flow returns to S19 and the subsequent control is performed. When the output V(R2) of the second rim sensor 12, multiplied by a predetermined coefficient is determined not to have exceeded the threshold value T(R1α), it is determined in S11 whether a predetermined time t(R1) has elapsed. In S11, when the predetermined time t(R1) is determined not to have elapsed, the flow returns to S9 and the subsequent control is repeated. When the predetermined time t(R1) is determined to have elapsed, in S12, the number of times i is set to 0, and in S13, the output maximum value V(Hmax) is multiplied by a coefficient β(R1) and ith power of a gradual decrease rate γ(R1) to set a threshold value T(R1β) (gradual decrease line).

Subsequently, in S14, it is determined whether the threshold value T(R1β) (gradual decrease line) has fallen below the minimum threshold value T(min). When the threshold value T(R1β) is determined to have fallen below the minimum threshold value T(min), the flow returns to S1 and the subsequent control is repeated. When the threshold value T(R1β) is determined not to have fallen below the minimum threshold value T(min), it is determined in S15 whether the output V(H) of the head sensor 10 has exceeded the threshold value T(R1β) (gradual decrease line).

In S15, when the output V(H) of the head sensor 10 is determined to have exceeded the threshold value T(R1β) (gradual decrease line), the flow returns to S2 and the subsequent control is repeated. When the output V(H) of the head sensor 10 is determined not to have exceeded the threshold value T(R1β) (gradual decrease line), it is determined in S16 whether the output V(R2) of the second rim sensor 12, multiplied by a predetermined coefficient has exceeded the threshold value T(R1β) (gradual decrease line).

In S16, when the output V(R2) of the second rim sensor 12, multiplied by a predetermined coefficient is determined to have exceeded the threshold value T(R1β) (gradual decrease line), the flow returns to S19 and the subsequent control is performed. When the output V(R2) of the second rim sensor 12, multiplied by a predetermined coefficient is determined not to have exceeded the threshold value T(R1β) (gradual decrease line), in S17, after lapse of the predetermined time period, 1 is added to the number of times i, then in S13, the threshold value T(R1β) (gradual decrease line) is set again, and subsequently, S14 to S17 are repeated.

Meanwhile, in S1, when the output V(H) (detection signal) of the head sensor 10 is determined not to have exceeded the minimum threshold value T(min), it is determined in S18 whether the output V(R2) (detection signal) of the second rim sensor 12 has exceeded a minimum threshold value T(R2 min) (a second minimum threshold value). When the determination is affirmative, in S19, the output maximum value V(Hmax) of the head sensor 10 in the predetermined time period is obtained. In S18, when the output V(R2) (detection signal) of the second rim sensor 12 is determined not to have exceeded the minimum threshold value T(min), the flow returns to S1 and the subsequent control is repeated.

When S19 is completed, in S20, the output maximum value V(R1 max) of the first rim sensor 11 in the predetermined time period is obtained, and in S21, the output maximum value V(R2 max) of the second rim sensor 12 in the predetermined time period is obtained. Subsequently, the flow proceeds to S23, and the respective output maximum values V(Hmax), V(R1 max) and V(R2 max) are added together with a predetermined ratio to determine a second rim strength determination output value V(R2δ).

Subsequently, in S24, a musical sound (a musical sound when the second rim 4 is hit) from the drum second rim corresponding to the second rim strength determination output value V(R2δ) is produced by the output 8. Subsequently, in S25, the head output maximum value V(Hmax) is multiplied by the coefficient α(R2) to set the threshold value T(R2α) (constant threshold value), then it is determined in S26 whether the output V(H) of the head sensor 10 has exceeded the threshold value T(R2α) (constant threshold value).

In S26, when the output V(H) of the head sensor 10 is determined to have exceeded the threshold value T(R2α) (constant threshold value), the flow returns to S2 and the subsequent control is repeated. When the output V(H) of the head sensor 10 is determined not to have exceeded the threshold value T(R2α) (constant threshold value), it is determined in S27 whether the output V(R2) of the second rim sensor 12, multiplied by a predetermined coefficient has exceeded the threshold value T(R2α).

In S27, when the output V(R2) of the second rim sensor 12, multiplied by a predetermined coefficient is determined to have exceeded the threshold value T(R2α), the flow returns to S19 and the subsequent control is performed. When the output V(R2) of the second rim sensor 12, multiplied by a predetermined coefficient is determined not to have exceeded the threshold value T(R2α), it is determined in S28 whether the predetermined time t(R2) has elapsed. In S28, when the predetermined time t(R2) is determined not to have elapsed, the flow returns to S26 and the subsequent control is repeated. When the predetermined time t(R2) is determined to have elapsed, in S29, the number of times i is set to 0, and in S30, the head output maximum value V(Hmax) is multiplied by a coefficient β(R2) and ith power of the gradual decrease rate γ(R2) to set a threshold value T(R2β) (gradual decrease line).

Subsequently, in S31, it is determined whether the threshold value T(R2β) (gradual decrease line) has fallen below the minimum threshold value T(min). When the threshold value T(R2β) is determined to have fallen below the minimum threshold value T(min), the flow returns to S1 and the subsequent control is repeated. When the threshold value T(R2β) is determined not to have fallen below the minimum threshold value T(min), it is determined in S32 whether the output V(H) of the head sensor 10 has exceeded the threshold value T(R2β) (gradual decrease line).

In S32, when the output V(H) of the head sensor 10 is determined to have exceeded the threshold value T(R2β) (gradual decrease line), the flow returns to S2 and the subsequent control is repeated. When the output V(H) of the head sensor 10 is determined not to have exceeded the threshold value T(R2β) (gradual decrease line), it is determined in S33 whether the output V(R2) of the second rim sensor 12, multiplied by a predetermined coefficient has exceeded the threshold value T(R2β) (gradual decrease line).

In S33, when the output V(R2) of the second rim sensor 12, multiplied by a predetermined coefficient is determined to have exceeded the threshold value T(R2β) (gradual decrease line), the flow returns to S19 and the subsequent control is performed. When the output V(R2) of the second rim sensor 12, multiplied by a predetermined coefficient is determined not to have exceeded the threshold value T(R2β) (gradual decrease line), in S34, after lapse of the predetermined time period, 1 is added to the number of times i, then in S30, the threshold value T(R2β) (gradual decrease line) is set again, and subsequently, S31 to S34 are repeated.

Meanwhile, in S22, when the ratio of the output maximum value V(R2 max) of the second rim sensor 12 to the output maximum value V(Hmax) of the head sensor 10 is determined not to be higher than or equal to a predetermined proportion, the flow returns to S35, and the respective output maximum values V(Hmax), V(R1 max) and V(R2 max) are added together with a predetermined ratio to determine a head strength determination output value V(Hδ).

Subsequently, in S36, a musical sound (a musical sound when the head 2 is hit) from the drum head corresponding to the head strength determination output value V(Hδ) is produced by the output 18. Subsequently, in S37, the head output maximum value V(Hmax) is multiplied by the coefficient α(H) to set the threshold value T(Hα) (constant threshold value), then it is determined in S38 whether the output V(H) of the head sensor 10 has exceeded the threshold value T(Hα) (constant threshold value).

In S38, when the output V(H) of the head sensor 10 is determined to have exceeded the threshold value T(Hα) (constant threshold value), the flow returns to S2 and the subsequent control is repeated. When the output V(H) of the head sensor 10 is determined not to have exceeded the threshold value T(Hα) (constant threshold value), it is determined in S39 whether the output V(R2) of the second rim sensor 12, multiplied by a predetermined coefficient has exceeded the threshold value T(Hα).

In S39, when the output V(R2) of the second rim sensor 12, multiplied by a predetermined coefficient is determined to have exceeded the threshold value T(Hα), the flow returns to S19 and the subsequent control is performed. When the output V(R2) of the second rim sensor 12, multiplied by a predetermined coefficient is determined not to have exceeded the threshold value T(Hα), it is determined in S40 whether the predetermined time t(H) has elapsed. In S40, when the predetermined time t(H) is determined not to have elapsed, the flow returns to S38 and the subsequent control is repeated. When the predetermined time t(H) is determined to have elapsed, in S41, the number of times i is set to 0, and in S42, the output maximum value V(Hmax) is multiplied by a coefficient β(H) and ith power of the gradual decrease rate γ(H) to set a threshold value T(Hβ) (gradual decrease line).

Subsequently, in S43, it is determined whether the threshold value T(Hβ) (gradual decrease line) has fallen below the minimum threshold value T(min). When the threshold value T(Hβ) is determined to have fallen below the minimum threshold value T(min), the flow returns to S1 and the subsequent control is repeated. When the threshold value T(Hβ) is determined not to have fallen below the minimum threshold value T(min), it is determined in S44 whether the output V(H) of the head sensor 10 has exceeded the threshold value T(Hβ) (gradual decrease line).

In S44, when the output V(H) of the head sensor 10 is determined to have exceeded the threshold value T(Hβ) (gradual decrease line), the flow returns to S2 and the subsequent control is repeated. When the output V(H) of the head sensor 10 is determined not to have exceeded the threshold value T(Hβ) (gradual decrease line), it is determined in S45 whether the output V(R2) of the second rim sensor 12, multiplied by a predetermined coefficient has exceeded the threshold value T(Hβ) (gradual decrease line).

In S45, when the output V(R2) of the second rim sensor 12, multiplied by a predetermined coefficient is determined to have exceeded the threshold value T(Hβ) (gradual decrease line), the flow returns to S19 and the subsequent control is performed. When the output V(R2) of the second rim sensor 12, multiplied by a predetermined coefficient is determined not to have exceeded the threshold value T(Hβ) (gradual decrease line), in S46, after lapse of the predetermined time period, 1 is added to the number of times i, then in S42, the threshold value T(Hβ) (gradual decrease line) is set again, and subsequently, S43 to S46 are repeated.

In the electronic drum according to the present embodiment, the sound source part 13 is configured to, when the output of the second rim sensor 12 exceeds a predetermined threshold value, produce a predetermined musical sound based on the output of the second rim sensor 12. The predetermined musical sound based on the output of the second rim sensor 12 is determined based on the detection signal output from the second rim sensor 12 and the detection signal output from the head sensor 10 or the first rim sensor 11. Thus, even immediately after a hit on the head 2 or the first rim 3, it is possible to reliably detect a hit on the second rim 4, and reliably produce and output a musical sound according to the hit on the second rim 4.

The sound source part 13 according to the present embodiment is configured to, when the output of the second rim sensor 12 exceeds a predetermined threshold value, output a predetermined musical sound based on the detection signal output from the second rim sensor 12 in relation to the total of a maximum value of the detection signal output from the second rim sensor 12 in a predetermined time period, and a maximum value of the detection signal output from the head sensor 10 or the first rim sensor 11 in a predetermined time period. Thus, a musical sound caused by a hit on the second rim 4 can be output according to the strength of the hit on the second rim 4.

In addition, according to the present embodiment, the AD converter 14 is provided, which is configured to convert analog signals detected by the head sensor 10, the first rim sensor 11 and the second rim sensor 12 into digital signals and output the digital signals, and the sound source part 13 is configured to add maximum values of the output in a predetermined time period, which has been converted by the AD converter 14, and determines a hit strength. Thus, as compared to when the outputs of the head sensor 10, the first rim sensor 11 and the second rim sensor 12 are added together, then converted to digital signals, the maximum output of the signal convertible by the AD converter 14 can be increased.

In addition, the second rim 4 according to the present embodiment is mounted on the body 1 with the elastic body (8a, 8b) interposed therebetween. Thus, it is possible to reliably block transmission of vibration between the head 2, the first rim 3 and the second rim 4, and reliably produce and output a musical sound according to a hit on the second rim 4. In addition, the second rim 4 according to the present embodiment is slidable along the peripheral edge of the first rim 3. Thus, the second rim 4 can be arranged at any position where a player can comfortably play, and a good performance can thereby be achieved.

In addition, according to the present embodiment, the sound source part 13 is configured to, when the detection signal from the head sensor 10 exceeds a first minimum threshold value (minimum threshold value T(Hmin)), compare the detection signal from the head sensor 10 with the detection signal from the first rim sensor 11 or the second rim sensor 12, and produce a predetermined musical sound according to the result of the comparison based on the detection signal from the head sensor 10, the first rim sensor 11 or the second rim sensor 12. Also, the sound source part 13 is configured to, when the detection signal from the second rim sensor 12 exceeds a second minimum threshold value (minimum threshold value T(R2 min)), produce a predetermined musical sound based on the detection signal from the second rim sensor 12. Thus, a hit on the second rim 4 can be preferentially detected by adjusting the first minimum threshold value and the second minimum threshold value as appropriate.

The sound source part 13 includes: the hit position identification part 15 configured to identify the hit position which has been hit, based on the detection signal output from the hit detection part; the threshold value setting part 16 configured to set a threshold value according to the hit position identified by the hit position identification part 15; and the musical sound production part 17 configured to produce and output a predetermined musical sound based on a detection signal which has exceeded the threshold value set by the threshold value setting part 16. The threshold value set by the threshold value setting part 16 forms a gradual decrease line which gradually decreases with a lapse of time, and the gradual decrease line is set individually for each hit position identified by the hit position identification part 15. Thus, a threshold value can be set in consideration of the vibration characteristics at each hit position, and even when the hit positions are consecutively hit, a musical sound according to each hit can be reliably produced and output.

Although the present embodiments have been described so far, the present disclosure is not limited. For example, the threshold value set by the threshold value setting part may not form a gradual decrease line which gradually decreases with a lapse of time, and only the head 2 and the second rim 4 may be provided as the hit positions (the first rim 3 may not be provided). When a gradual decrease line is formed by the threshold value set by the threshold value setting part 16, the gradual decrease line may have a curved shape, a linear shape or a discontinuous shape. Note that with the threshold value according to the present embodiment, a gradual decrease line is set subsequent to a constant threshold value, but only a constant threshold value, or only a gradual decrease line may be set. In addition, the first minimum threshold value and the second minimum threshold value may not be common, and the position of the second rim may be adjustable by providing multiple screw holes without using the long hole 8ca.

The disclosure is applicable to an electronic drum having a different external shape or another additional function provided that the sound source part is configured to, when the output of the second rim sensor exceeds a predetermined threshold value, produce a predetermined musical sound based on the output of the second rim sensor, and the predetermined musical sound based on the output of the second rim sensor is determined based on the detection signal output from the second rim sensor, and the detection signal output from the head sensor or the first rim sensor.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electronic drum comprising:
a body having a head and a first rim allowed to be hit by a player;
a second rim elastically supported and mounted on the body, the second rim being allowed to be hit by a player;
a head sensor mounted on the body, the head sensor detects a hit on the head and output a predetermined detection signal;
a first rim sensor mounted on the body, the first rim sensor detects a hit on the first rim and output a predetermined detection signal;
a second rim sensor mounted on the second rim, the second rim sensor detects a hit on the second rim and output a predetermined detection signal; and
a sound source part produces and outputs a predetermined musical sound based on the detection signal output from the head sensor, the first rim sensor or the second rim sensor,
wherein the sound source part, when the output of the second rim sensor exceeds a predetermined threshold value, produces a predetermined musical sound based on the output of the second rim sensor, and the predetermined musical sound based on the output of the second rim sensor is determined based on the detection signal output from the second rim sensor, and the detection signal output from the head sensor or the first rim sensor.

2. The electronic drum according to claim 1, wherein the sound source part, when the output of the second rim sensor exceeds a predetermined threshold value, outputs a predetermined musical sound based on the detection signal output from the second rim sensor in relation to a total of a maximum value of the detection signal output from the second rim sensor in a predetermined time period, and a maximum value of the detection signal output from the head sensor or the first rim sensor in a predetermined time period.

3. The electronic drum according to claim 2, further including
an AD converter that converts analog signals detected by the head sensor, the first rim sensor and the second rim sensor into digital signals, and outputs the digital signals,
wherein the sound source part obtains the total of the maximum values of the output, in a predetermined time period, which has been converted by the AD converter, and determines a hit strength.

4. The electronic drum according to claim 1, wherein the second rim is mounted on the body with an elastic body interposed between the second rim and the body.

5. The electronic drum according to claim 4, wherein the second rim is slidable along a peripheral edge of the first rim.

6. The electronic drum according to claim 1, wherein when the detection signal from the head sensor exceeds a first minimum threshold value, the detection signal from the head sensor is compared with the detection signal from the first rim sensor or the second rim sensor, and a predetermined musical sound is produced according to a result of the comparison based on the detection signal from the head sensor, the first rim sensor or the second rim sensor, whereas when the detection signal from the second rim sensor exceeds a second minimum threshold value, a predetermined musical sound is produced based on the detection signal from the second rim sensor.
